(19) United States
(12) Patent Application Publication
(10) Pub. No.: US 2011/0149583 A1
(43) Pub. Date: Jun. 23, 2011

(54) LENS MODULE SOCKET

(76) Inventor: Chin-Chou Wang, Tu-Cheng City (TW)

(21) Appl. No.: 12/642,807

(22) Filed: Dec. 19, 2009

(51) Int. Cl. F21V 17/00

(52) U.S. Cl. 362/455

(57) ABSTRACT

A lens module socket for receiving a lens module having a base portion includes an insulating housing, a plurality of conductive terminals and a shielding shell. The insulating housing has a bottom wall and side walls extended upwardly from the bottom wall to surround a receiving chamber therebetween for receiving the lens module. Two opposite side walls each defines at least one through hole thereon and a latch member disposed in the through hole. The latch member includes an arm portion extended upwardly from a bottom of the through hole and a hook portion projected into the receiving chamber from an upper position of the arm portion for buckling the lens module without gap formed between the bottom wall and a bottom of the lens module. The hook portion has an inclined guide surface for guiding the lens module during the lens module is assembled to the insulating housing.

### BACKGROUND OF THE INVENTION

1. Field of the Invention

The present invention relates to a lens module socket, and more particularly to a lens module socket for receiving a lens module to reduce the total height of the assembly thereof

2. The Related Art

Because of the development of wireless communication and the rapid revolution in high technology, portable electronic products, such as mobile phones, PDAs and notebook computers, are assembled with different electronic additional-modules such as lens modules for taking pictures and satisfying desires of consumers. Correspondingly, the lens module sockets spring up for the lens modules.

In general, a lens module socket includes an insulating housing defining a receiving chamber therein for receiving a lens module, a plurality of conductive terminals received in the insulating housing, and a shielding shell encircling the insulating housing. The insulating housing has a bottom wall and four side walls extended upwardly from the bottom wall to surround the receiving chamber therebetween. The bottom wall defines a plurality of terminal grooves for receiving the conductive terminals. The shielding shell defines a plurality of spring plates bent into the receiving chamber. When the lens module is received in the receiving chamber, the spring plates press down the lens module then the lens module presses down and electrically connects with the conductive terminals.

Because the spring plates could not provide enough pressure to make the lens module press down the conductive terminals completely, then the conductive terminals correspondingly push the lens module upwardly to form a gap between the bottom wall and a bottom of the lens module. As a result, the total height of the assembly of the lens module and the conventional lens module socket is increased consequently. Therefore, it is difficult to fulfill the smaller-size requirement of the electronic products.

### SUMMARY OF THE INVENTION

It is an object of the present invention to provide a lens module socket for receiving a lens module to reduce the total height of the assembly thereof. In order to achieve above-mentioned object, the lens module socket of the present invention for receiving a lens module having a base portion includes an insulating housing, a plurality of conductive terminals received in the insulating housing, and a shielding shell encircling the insulating housing. The insulating housing has a bottom wall and side walls extended upwardly from the bottom wall to surround a receiving chamber therebetween for receiving the lens module. Two opposite side walls each defines at least one through hole thereon and a latch member disposed in the through hole. The latch member includes an arm portion extended upwardly from a bottom surface of the through hole and a hook portion projected into the receiving chamber from an upper position of the arm portion. The hook portion has an inclined guide surface for guiding the lens module. Wherein during the lens module is assembled to the insulating housing, two opposite sides of the base portion of the lens module press against the guide surfaces to make the arm portions expand outwardly, when the base portion passes from the guide surfaces, the arm portions revert to an original state to make the hook portions buckle two opposite portions of a top of the base portion.

As described above, the hook portions of the latch members tightly buckle two opposite portions of a top of the base portion of the lens module to make the lens module received in the insulating housing without gap formed between the bottom wall and a bottom of the lens module, which reduces the total height of the assembly of the lens module socket and the lens module.

### BRIEF DESCRIPTION OF THE DRAWINGS

The present invention will be apparent to those skilled in the art by reading the following description of an embodiment thereof, with reference to the attached drawings, in which:

FIG. 1 is a perspective view of a lens module socket in accordance with the present invention and a lens module suitable for the lens module socket;

FIG. 2 is an exploded view of the lens module socket shown in FIG. 1; and

FIG. 3 is a cross-sectional view showing the lens module assembled to the lens module socket.

### DETAILED DESCRIPTION OF THE PREFERRED EMBODIMENT

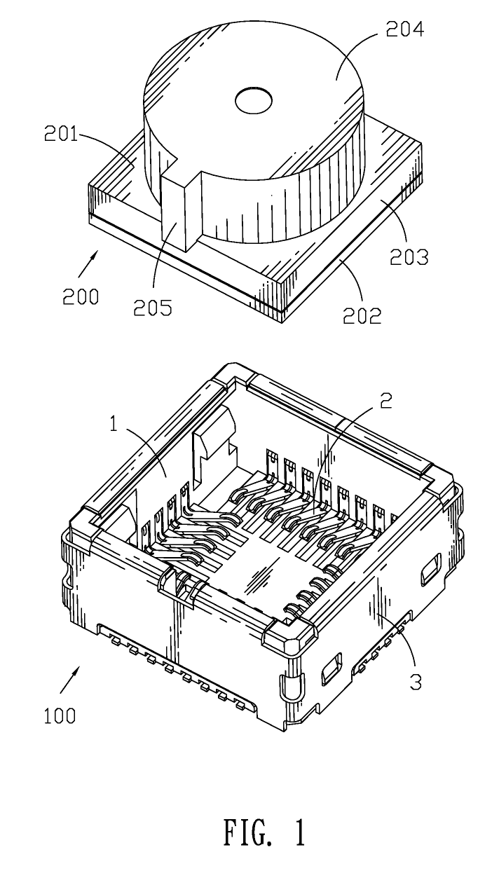

With reference to FIG. 1, a lens module socket 100 according to the present invention and a lens module 200 suitable for the lens module socket 100 are shown. The lens module socket 100 includes an insulating housing 1, a plurality of conductive terminals 2 received in the insulating housing 1, and a shielding shell 3 encircling the insulating housing 1. The lens module 200 includes a main body 201 and a printed circuit substrate 202 attached to a bottom of the main body 201. The main body 201 has a substantially rectangular base portion 203 and a substantially cylindrical lens portion 204 extended from a top of the base portion 203. The lens portion 204 has a projection 205 provided at an outer periphery thereof

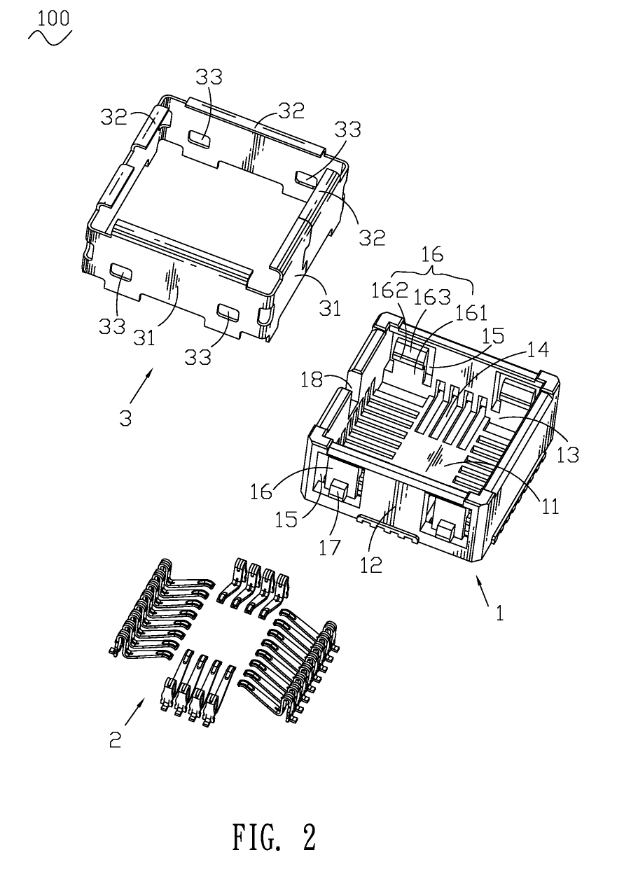

Referring to FIG. 2, the insulating housing 1 has a flat bottom wall 11 and four side walls 12 respectively extended upwardly from four sides of the bottom wall 11 to surround a receiving chamber 13 therebetween. The bottom wall 11 defines a plurality of terminal grooves 14 extended to the side walls 12 for receiving the plurality of conductive terminals 2. Two opposite side walls 12 each defines two through holes 15 respectively disposed at two sides thereof. Each of the through holes 15 has a latch member 16 disposed therein and a fixed member 17 attached to a lower position of an outside of the latch member 16. The latch member 16 includes an arm portion 161 extended upwardly from a bottom of the through hole 15 and a hook portion 162 projected into the receiving chamber 13 from an upper position of the arm portion 161. The hook portion 162 has an inclined guide surface 163. One of the other two opposite side walls 12 defines a location trough 18 at an upper position thereof for correspondingly receiving the projection 205 of the lens module 200.

The shielding shell 3 has four side plates 31 connected to each other to form a hollow square or rectangle. The side plates 31 have a plurality of rim portions 32 extended inwardly from top edges thereof. Two opposite side plates 31 each defines two fixed holes 33 respectively disposed at two sides thereof for corresponding to the fixed members 17. The shielding shell 3 is assembled in a downward direction to encircle the insulating housing 1. The four side plates 31 wrap around the four side walls 12. The rim portions 32 press on top surfaces of the side walls 12. The fixed members 17 are received in the corresponding fixed holes 33.

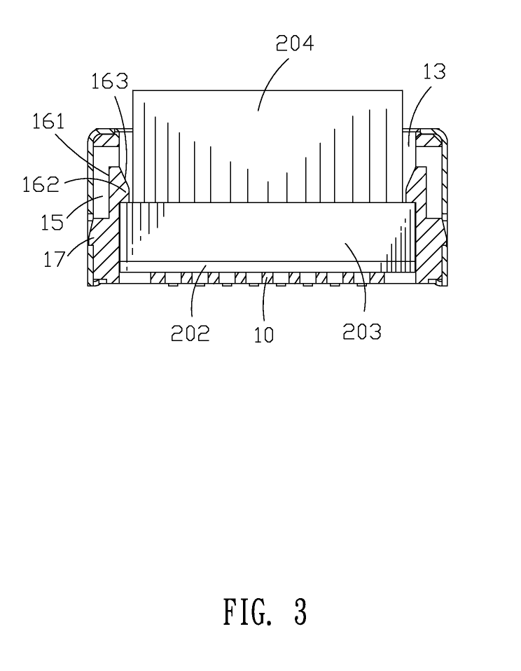

Referring to FIG. 1 and FIG. 3, during the lens module 200 is pressed downward to be assembled to the lens module socket 100, two opposite sides of the base portion 203 presses against the inclined guide surfaces 163 of the latch members 16 to make the arm portions 161 expand outwardly. When the base portion 203 passes from the guide surfaces, the arm portions 161 revert to the original state, because of the resilience thereof, to make the hook portions 162 tightly buckle two opposite portions of the top of the base portion 203. In this case, the lens module 200 is firmly received in the receiving chamber 13 of the insulating housing 1 without gap formed between the bottom wall 10 and the printed circuit substrate 202. Therefore, the assembly of the lens module socket 100 and the lens module 200 has reduced the total height. And meanwhile, the conductive terminals 2 are pressed to electrically connect with the printed circuit substrate 202.

As described above, the hook portions 162 of the latch members 16 tightly buckle two opposite portions of the top of the base portion 203 to make the lens module 200 received in the insulating housing 1 without gap formed between the bottom wall 10 and the printed circuit substrate 202, which reduces the total height of the assembly of the lens module socket 100 and the lens module 200.

What is claimed is:

1. A lens module socket for receiving a lens module having a base portion, comprising:
an insulating housing, the insulating housing having a bottom wall and side walls extended upwardly from the bottom wall to surround a receiving chamber therebetween for receiving the lens module, two opposite side walls each defining at least one through hole thereon and a latch member disposed in the through hole, the latch member including an arm portion extended upwardly from a bottom of the through hole and a hook portion projected into the receiving chamber from an upper position of the arm portion, the hook portion having an inclined guide surface for guiding the lens module, wherein during the lens module is assembled to the insulating housing, two opposite sides of the base portion of the lens module press against the guide surfaces to make the arm portions expand outwardly, when the base portion passes from the guide surfaces, the arm portions revert to an original state to make the hook portions buckle two opposite portions of a top of the base portion;
a plurality of conductive terminals received in the insulating housing for electrically connected with the lens module; and
a shielding shell, the shielding shell having side plates connected to each other for encircling the side walls of the insulating housing.

2. The lens module socket as claimed in claim 1, wherein the latch member has a fixed member attached to a lower position of an outside thereof, two opposite side plates of the shielding shell each defines a fixed hole thereon for correspondingly receiving the fixed member.

3. The lens module socket as claimed in claim 1, wherein the bottom wall defines a plurality of terminal grooves extended to the side walls for receiving the conductive terminals therein, the lens module includes a printed circuit substrate pressing down and electrically connecting with the conductive terminals.

4. The lens module socket as claimed in claim 1, wherein the side plates of the shielding shell have a plurality of rim portions extended inwardly from top edges thereof for pressing on top surfaces of the side walls of the insulating housing.
